(19) United States
(12) Patent Application Publication
(10) Pub. No.: US 2002/0149681 A1
(43) Pub. Date: Oct. 17, 2002

(54) Automatic image capture

(76) Inventors: Richard Oliver Kahn, Oakland, CA (US); David Arthur Grosvenor, Bristol (GB); Stephen Philip Cheatle, Bristol (GB)

Correspondence Address: LOWE HAUPTMAN GOPSTEIN, GILMAN AND BERNER LLP, 1700 DIAGONAL ROAD, SUITE 310 /310, ALEXANDRIA, VA, 22314, US

(21) Appl. No.: 10/107,808

(22) Filed: Mar. 28, 2002

(30) Foreign Application Priority Data
Mar. 28, 2001 (GB) 0107791.6

(51) Int. Cl. H04N 5/225

(52) U.S. Cl. 348/211.99; 348/211.2

(57) ABSTRACT

Imaging apparatus for use with a tag 5 providing information comprises an electronic still or video camera 1 for providing an image signal 6, tag detecting means 8 for detecting the location of the tag and tag reading means 9, 10 for deriving the predetermined information from the tag, and image signal control means 11 to 13 for controlling the image signal in response to the output of the means 8 to 10 to provide a selected picture signal. As shown when a visitor enters a site details from a keyboard 16 are stored in a central computer 15 and printed 17 as a visible bar code tag 5 which is recognised 8 and provides a tag identity 9 and picture signal instructions 10. The latter act in conjunction with an image decision circuit 11 for judging picture composition, e.g. pan, tilt, zoom, and with an event detector 12 for picture timing (e.g. the occurrence of a smile on a visitor 4 wearing tag 5), for selective enablement of an image signal selection circuit 13, the selected signal being combined with the tag identity signal at 14 and stored 15. Circuits 11 and 12 preferably comprise image analysis means. On the visitor leaving the site, tag 5 is read 19 and a message displayed to indicate that pictures await. Tags may specify that group pictures only are to be taken, or that a tag associated with a site location needs also to be present.

The present invention relates to a camera for use in an automatic camera system, and to an automatic camera system.

It is often advantageous to impose automatic or semi-automatic control on one or more video or still cameras. For example, continuous control of pan and tilt, and where possible, zoom, allows a camera to track an object once it has been identified in the field of view, and permits the object to be tracked between one camera and another. This has clear potential in applications such as security installations; the televising of sporting and other like events; and the reduction of the number of necessary personnel in a studio, for example where a presenter is free to move. It is also known to adjust the camera for tilt about the lens axis so that vertical lines are correctly rendered in the image, which is useful when a portable camera is in use.

In another application of automated imaging, still or video images are captured of people moving within a fixed framework and along generally predetermined paths. For example, visitors to a funfair may have their pictures taken when they reach a predetermined point in a ride.

Automation, however, also brings with it a number of related problems. The absence of input from a camera operator, whether in a remote fixed camera installation or in a camera which may be carried or worn by a user who relies on automatic operation, for example knowing which target to image and controlling pan/tilt/zoom, framing and composition accordingly, together in certain cases with transmission of the images to the correct location, need effectively to be replaced by automated means, and recently there has been interest in the use of tags for at least some of these ends.

Thus in International Patent Application No. WO 00/04711 (Imageid) there are described a number of systems for photographing a person at a gathering such as a banquet or amusement park in which the person wears an identification tag that can be read by directly by the camera or by associated apparatus receiving an image signal from the camera signal or from a scanner if the original image is on film. In these systems, the tag can take the form or a multiple segmented circular badge, each segment being of a selected colour to enable identification of the badge as such, and to enable identification of the wearer. Identification of the wearer enables the image, or a message that the image exists, to be addressed to the correct person, e.g. via the Internet.

International Patent Application No. WO 98/10358 (Goldberg) describes a system for obtaining personal images at a public venue such as a theme park, using still or video cameras which are fixed or travel along a predetermined path. An identification tag is attached to each patron for decoding by readers at camera sites, although camera actuation may be induced by some other event such as a car crossing an infra-red beam or actuating a switch. The tag information is also used for image retrieval of that patron. The tag may be, for example a radio or sound emitter, an LED (including infra-red), or comprise a bar code or text. Alternatively, techniques such as face recognition or iris scanning could replace the tag. Similar types of system are described in U.S. Pat. Nos. 5,694,514 (Lucent); and 5,655,053 and 5,576,838 (both Renievision). A camera system with image recognition is also described in U.S. patent application Ser. No. 5,550,928.

In these systems, the tag is used principally for activation of the camera and for coded identification of the target within the viewed image, and there is no other control of the image produced. Although the presence of a tag is necessary, its position within the scene is not ascertained or used in the imaging process.

European Patent Application No. 0 953 935 (Eastman Kodak) relates to an automatic camera system in which a selected video clip is made into a lenticular image.

European Patent Application No. 0 660 131 (Osen) describes a camera system for use at shows such as an airshow, a sporting event, or racing, where the position of the target is provided by a GPS system and used to point the camera correctly.

In U.S. patent application Ser. No. 5,844,599 (Lucent) is described a voice following video system for capturing a view of an active speaker, for example at a conference. In an automatic mode, each speaker is provided with a voice activated tag which detects when a person is speaking and emits infra-red radiation in response thereto, thus enabling a controller to operate a camera so as to pan/tilt/zoom from the previous speaker, or to move from a view of the entire assembly. The controller includes means for detecting the position of the infra-red emitter using optical triangulation, and there may additionally be provided means for analysing the camera output to locate the speaker's head and shoulders for further adjustments of the field of view. In this system, the tag identifies itself to the camera when it is necessary to view its wearer, but provides no information peculiar to itself or the wearer. The camera is controlled according to tag activation and the position of the activated tag as determined by detection of the position of the infra-red emission. The tag itself is not adapted to provide any predetermined information, only whether or not the associated person is speaking.

The requirements for video imaging of a speaker at a conference, where the participants are all present within a limited framework, and where it is unnecessary to identify individual known participants, are rather different from those pertaining in many other potential automated camera locations, such as a theme park or other public event where it is not known in advance who will be present or what they will be doing at any time.

The present invention provides imaging apparatus for use with a tag providing information, said apparatus comprising an electronic camera for providing an image signal, tag responsive means including tag locating means for detecting the presence of a tag and determining its location relative to the camera and tag reading means for deriving said predetermined information from said tag, and image signal control means for controlling the image signal in response to the output of said tag detecting and reading means to provide a selected picture signal.

The camera may be a still camera or a video camera. Preferably it is a digital camera, and may comprise a CCD or CMOS array of sensors.

The camera may be part of a fixed installation, for example a camera viewing an area in the vicinity of an exhibit, or a portable camera, for example being carried or worn by a visitor to an exhibit or theme park. Particularly when it is portable, there is always that the camera may be rotated about the lens axis so that vertical lines in the viewed scene appear to be sloping in the resulting picture. Accordingly, when the camera is carried it may be provided with suitable carrying means such as a shoulder strap or cradle which in use tends to maintain it in the correct position. Where the camera is worn, for example on a visitor's head, the mounting may be such as to point approximately in the direction of the wearer's eyes, for example.

The camera may additionally or alternatively comprise means for acting on the sensor array and/or the output signal for ameliorating the effect of rotation about the lens axis (see later).

The present invention enables the production of an output image signal in which a degree of composition has been applied according to predetermined criteria.

Composition of a picture needs to take into account camera direction (essentially camera pan and tilt; image size; and the time when a still image signal from the camera is selected, or when the start of a video clip is begun, for recordal and/or reproduction purposes. In the invention, at least one or more of these factors, and preferably all of them, are under the control of the image signal control means which thus controls the image content of the resulting signal, whether this is the signal derived directly from the camera (if control is by physically altering the camera settings or electronically altering the scan pattern) or by subsequent editing of the image signal from the camera, or both.

There is a further degree of camera movement involving rotation about the lens axis. For present purposes, this will generally be in the nature of a corrective function, rather than one concerned with composition as the term is normally understood, although for certain pictures it does need to be controlled for good composition. It should be understood that this feature may be present in any apparatus according to the invention, that it may be employed for corrections of “non-verticality” or for artistic purposes as required, and that it may be under control of the image signal control means, or a separate means provided for the purpose. However, no further reference will be made to controlling rotation of camera (or signal) view about the lens axis.

Pan and Tilt

Camera direction (pan and/or tilt) can be used for placement of a selected object relative to the frame, and/or for cropping out edge features deemed to be undesirable. Pan and tilt may be controlled by physical control of the camera itself; by electronic control of the camera, for example by controlling the position of a sub-area of a sensor array which is scanned; by acting on the image signal from the camera before or after recordal to select that part which relates to a selected (limited) part of the field of view; or by any combination of two, or all, of these three techniques.

Zoom

A degree of image selection and cropping is obtainable by pan and tilt control, but zoom control is a further or alternative refinement. This again may be effected by physical control of the camera if it is provided with a zoom lens; or by electronic control of the camera, for example by controlling the magnitude of a sub-area of a sensor array which is scanned; by acting on the image signal from the camera before or after recordal to select a part which relates to a limited portion of the field of view; or by any combination of two, or all, of these three techniques.

In one preferred embodiment, the camera comprises a sufficiently fine (high resolution) and large sensor array together with a lens covering a relatively large field of view to enable pan, tilt and zoom effects to be obtained by control of the scan, or by editing of the resulting image signal, without discernible loss of visual resolution, so that physical control of these factors can be avoided.

All of the above factors (pan, tilt, zoom, rotation about the lens axis) can be grouped together under the term “camera settings”, and hereinafter it should be understood that where reference is made to the control of camera settings these could be effected under physical and/or electronic control.

Where the image signal is edited to effect any of these settings, means may be provided for interpolation between pixels in known manner.

Whether or not the above camera settings are controlled, and regardless of how they are controlled, the timing of the selected picture signal (regardless of whether it denotes the time at which a still image is selected, or a sequence of still pictures commences, or a video clip begins) will also need to be controlled in some way, particularly where compositional considerations are given due weight. In general the timing will have a predetermined temporal relation to an event, exemplary typical events being:

(a) The first appearance of the tag in the field of view, for a simple system;

(b) The appearance of a predetermined feature associated with the tagged object, for example a smile from the user;

(c) The occurrence of a visible action in the field of view, for example, an action have a speed above a threshold value;

(d) Triggering of a separate event, for example operation of an exhibit likely to cause a particular reaction from a bystander;

(e) The appearance or arrival of a separate object at a predetermined position, for example the arrival of a car on a ride; and

(f) A non-visual event, such as the sound of laughter.

(g) The emission from a suitably arranged tag, of a signal initiated by the wearer, e.g. instructing that a picture should be taken regardless of other considerations.

Such events can be detected in ways known per se, and may require a separate event detector. In typical arrangements the timing of the selection of the picture signal could coincide with the occurrence of the event or it may occur a predetermined interval thereafter.

The event detector may include an inhibit input to prevent picture taking if other conditions as detected as not appropriate, for example if movement within the field of view is excessively fast, if the prevailing illumination is insufficient, or if other camera operating requirements (see below in respect of “more than one tag” for example) are not fulfilled.

The tag may be any device capable of being located and of providing the said information. It may act as a radiation emitter, e.g. of visible or (preferably) infra-red light, ultrasound or radio waves, which can be detected for determining its presence and position, e.g. by a plurality of spaced sensors the outputs of which are subject to a triangulation algorithm.

Alternatively the tag may be a passive device capable of being recognised, such as a visible or infra-red bar code or a colour segmented disc. It may also take the form of a transponder for any of the above forms of radiation.

Where the tag is active in the infra-red part of the spectrum, the camera may comprise an infra-red sensitive sensor array, either a separate entity receiving light from a beam splitter in a manner known per se, or sensors interspersed with those of the visible sensor array for providing a separate IR image signal. Where the tag is optical, an autofocus system may be used to determine distance, and an imaging sensor array may be used to determine the other location data.

Where the tag is located by a sensor separate from the camera, it will be necessary to calculate by means known per se the spatial relation of the tag to the camera. Preferably the tag sensor is located close to or at the camera to avoid problems of parallax, and generally a non-coincidence of the views from tag sensor and camera. For example, a tag may be visible to the sensor, but the wearer may be occluded from the camera view.

The use of non-optical tags is advantageous insofar as their location can be detected, and information derived therefrom, even if they are partly or completely obscured by another object in the field of view. However, this is not always desirable, since it may result in the taking of pictures where the main object of interest is invisible or only partially visible.

Optical tags, on the other hand, will only be effective when they are not obscured and at least part of the associated object is clearly present in the field of view (where the tag detector is separate from the camera this will need to be taken account of). Image analysis will confirm how much of the associated object is in view, and can be used in controlling the timing of selection of the picture signal. A possible drawback is that the tag must be picked out from the pictorial background by virtue of its pattern and/or shape. Not only might this be difficult under certain circumstances, but the tag appears as a visible object in the resulting picture, at least before being edited out.

Where a tag includes a radiating device, problems of energy limitation may arise. According it is also envisaged that such tags could be provided with a sleep mode, and that the camera apparatus includes means for sending our interrogatory signals for awaking any tags in the vicinity. Alternatively a tag may be arranged as a transponder to a signal produced by the camera apparatus.

The information provided by the tag may take any desired format. It may include identification information, for example identifying the tag and/or the wearer. The apparatus may include means for automatically collating this information with other information held in a local or remote database, for example linking the tag information, which thus acts as a pointer to further information, to an e-mail or other address of a wearer. Thus in use of one form of apparatus according to the invention, a tag is given to a visitor to wear after recording the tag and visitor details at a local database, the tag is subsequently identified when a picture is taken, and a message is subsequently automatically sent to the wearer that a picture is available for viewing.

Alternatively or (preferably) additionally, the information may contain image signal operating instructions, which are used to modify the manner in which the image signal control means operates.

The information provided by the tag may be provided by the same mechanism as the tag is located. For example, the information may be modulated on the emitted or transponded radiation, or arise from a visible or infra-red tag recognition process. However, it would be possible for the tag location to be detected by one mechanism and for the information to be provided by an alternative mechanism.

The image signal control means is responsive to the output of the tag detecting and reading means. The latter comprises tag detecting means for determining the tag location relative to the camera, and information means for determining the tag information. The image signal control means may be responsive to the tag location and/or the tag information as desired.

Tag location is one way of providing an input for control of picture composition. It may be determined in two dimensions relative to the field of view of the camera, or as the pixel area of the camera sensor corresponding to the tag, or as two directions relative to the camera position (it will be appreciated that it is computationally easy to transform one such measurement to another as desired). It may additionally include distance from the camera, although this will often require a further tag location sensor above that or those necessary for determining the other two dimensions.

In one fairly basic form of apparatus according to the invention the control means is arranged for controlling at least one of the camera settings so that the tag has a predetermined relation to the camera view. Thus the camera may be pointed (pan/tilt) so that the tag appears at a predetermined location in the frame, and/or the zoom may be adjusted so that the tag has a predetermined size in the frame (measurement of tag size presupposes a knowledge of its position). In this basic form the image signal control means may include timing means for triggering recordal of said image signal a predetermined time after initial location of a said tag.

However, it is possible to build in a much greater degree of sophistication in apparatus according to the invention, for providing more desirable image compositions, and for dealing with situations where more than one tag is present in the field of view.

The image signal control means may comprise image analysis means for receiving the output signal from the camera. This can perform different functions as required. Where the tag is visible, the image analysis means may be arranged to act as the tag detecting means, providing an indication of tag location. It can also act as the information means if the latter is readable in the visible spectrum. A further function is the detection of a visible event for determination of the timing of the selected picture signal, i.e. it can serve as the event detector. A yet further function is to act as a composition determining means for the determination of picture composition, and this will now be discussed later.

It is known to analyse an image signal to determine an appropriate composition by the employment of suitable algorithmic control embodying a set of predetermined rules. In one such method, the image signal is subjected to segmentation based on the selection of broad basic areas of substantially the same hue regardless of minor detail. On the basis of such basic areas and their relation to one another decisions can be made as to what are the interesting areas (which each may comprise one or a plurality of the basic areas) and what should if possible be included and excluded from the picture. It is also possible to identify the basic areas which are likely to be associated with a single object (for example the face, torso and legs of the visitor). This approach can thus permit the distinguishing of areas of interest from a general background and other detail likely to be irrelevant. Once there has been gained an indication of the areas and objects of interest within the view, account is taken of the tag location, and the predetermined rules are further implemented to make a decision for example as to where precisely the camera should be pointed and what should be the zoom setting, to give a well aimed and cropped picture, in response to which decision the image signal control means adjusts the camera settings. Alternatively the tag location may be used as a seed point for the segmentation process.

Although it commonly occurs, it is not necessary for the tag to lie within the field of view. While the tag will mark the associated object, it may be that the eventual composition is such that the tag lies outside the picture area. For example, a tag may be worn on the body of a visitor, which is identified thereby, but the image analysis may be used to determined a field of view which includes only the head and shoulders, or just the face, of the wearer. In other cases, however, where a full body view is required, then the tag will be within the picture field.

As previously mentioned, the tag information may include camera image signal operating instructions. For example, there may be instructions as to:

(a) The type of image to be taken, for example close-up (head and shoulders); or tightly cropped to the wearer's body; or a wider angle view. Where there is image analysis means acting as composition determining means, this may be accomplished by providing different predetermined sets of composition rules, and using the tag to select the desired set.

(b) For a still camera, the number of pictures to be taken at any specified location, and the timing involved (e.g. regular intervals, or as determined by the presence of other tags, see later). For a video camera the length of the clip.

(c) The event to be detected for determination of the imaging instant. There may be more than one type of event detector available, and the tag information will then indicate which detector is to be employed.

(d) Other compositional requirements. For example whether or not, having identified a person to be imaged, the event detector is disabled in dependence on whether the person's outline is intersected by another major area of interest (e.g. a second person. Another circumstance which may need to be taken into account is the appearance of more than one tag in the field of view, and this will now be discussed.

More Than One Tag

Under many conditions of use, there may be more than one tag in the field of view. In a simple arrangement, the tag locating means may be arranged to detect and identify only the first tag which appears, until a picture has been taken, after which it may be freed up to detect a second tag and thereafter to ignore the first tag.

However, preferably the tag locating means is capable of simultaneously locating more than one tag within its field of view. In such a case it is preferable if the information means is capable of simultaneously deriving information from said more than one tag.

The second tag may or may not bear a predetermined relation to the first tag. It may or may not be associated with the same type of object as the first tag. Typical options which present themselves are:

(A) Picture related to one tag.

(B) Related tags. Take picture including a predetermined minimum, e.g. 2 or 3, related tags only.

(C) Unrelated tags present, for different types of associated object. Take picture including at least one tag for each type of associated object. Predetermined minima may be set for the numbers of each sort of tag to be present.

In each of the above options, there may be a further option to (i) disregard the presence of any other tags, or specified tags; or (ii) inhibit picture taking when any other tags, or any specified tags, are present, i.e. to positively exclude the association of certain tag combinations.

Option (A) above may apply when a person requires only individual pictures of themselves. The tag may be set to dictate that the presence of other people (wearing tags) is either immaterial, or that such pictures should not be taken. The compositional rules will then be set in relation to the wearer as the principal subject of the picture.

In this option the image signal control means may be so adapted as to place the tags in a priority order according to predetermined criteria, for example order of appearance in the field of view, or order of detection, and to prepare to take images related to said tags is said predetermined order. Where for some reason the composition determining means determines that it is not appropriate to take a picture related to the first tag in the order, it may be placed to the back of the queue, and next tag used, etc. Similarly, when plural pictures related to the same tag are required, one picture may be taken and the tag placed to the back of the queue for the next image, etc., which could have the virtue of precluding one tag from dominating camera operation, e.g. in busy periods, or the plurality of pictures may be taken before another tag is considered.

Option (B) above may apply when visitors are issued with related tags, which are set so that pictures are taken only when more than a predetermined number of related tags, or preferably the associated people, are in the picture. Related tags could be issued for example to visitors from the same party, including family groups. The compositional rules will then be set so that each of the related tag wearers is included in the frame, and there may be further rules governing the necessary spatial relation between the tags before a picture can be taken. Where it is determined that plural visitors from two or more parties are simultaneously present, the individual parties may be dealt with along the lines of the priority ordering outlined for (A).

In this option, one or more of the related tags may take priority and must necessarily be present before a picture is taken, whereas other tags merely serve the function of completing the tag number requirement, and cannot of themselves initiate the taking of a picture. Thus on the occasion of a birthday treat to a theme park, a child whose birthday it is may have a priority tag, and then other children may be issued with related tags, so that the birthday child appears in each picture with another child of the same group but regardless of which particular other child that is.

Option (C) may apply when, for example, an animal at a zoo wears a second type of tag, and a visor wears a first tag dictating that at least one second type of tag must be present before a picture is taken, thus ensuring that pictures are taken of a visitor in conjunction with the presence of an animal or other feature (not necessarily mobile, for example it could be a fixed exhibit or building which needs to be included in the picture, but otherwise with as close a crop as possible to include the tag wearer). When an adult and children visit an attraction, it may be appropriate for a child to be pictured together with a feature, e.g. Mickey Mouse, but not the adult, and the tags will be configured accordingly. Again, minimum numbers of the first and second types of tag may be predetermined is appropriate, and the framing is adjusted to include both tag wearers, with if necessary further rules governing the necessary spatial relation between the tags before a picture can be taken (so that for example, the visitor does not obscure the animal.

It will be clear that the apparatus of the invention can be arranged to operate in a multiplexing mode wherein pictures pertaining to more than one tag or group of related tags are obtained within the same time period.

The invention extends to method of imaging a scene with a camera in which at least one information bearing tag is present comprising the steps of, determining the location of the tag, deriving said information from the tag, and controlling the camera at least in part on at least one of said location and said information.

The direction of the camera may be controlled according to the tag location. The zoom of the camera may be controlled according to the distance of the tag from the camera.

An image signal from the camera may be analysed and this can serve a number of purposes. It may provide a determination of the location of the tag. It may provide the tag information. It may involve detecting a predetermined event for determining when the camera is to be triggered and an image signal recorded. It may involve making a decision on best picture composition according to predetermined criteria, and in such a case the composition can be adjusted in response thereto by controlling camera direction and/or zoom and/or by editing an image signal from the camera. However, in the latter case other means for detecting predetermined events may be used, depending on the type of event.

Where the tag emits light, the light is preferably in the infra-red to avoid the normal imaging process, although it would be possible to arrange the normal image to be filtered to exclude an emitted visible wavelength without too much disruption provided the emitted wavelength and the filtering occupied a sufficiently narrow waveband.

Reference has so far been made to the use of a single camera at any one location. However, it should be noted that a plurality of cameras could be provided having coincident or overlapping fields of view. Where separate tag detecting and reading means, and/or separate event detectors, are present, these may be common to at least some of the plurality. Furthermore, other functions, such as those of the image analysis means, or image signal editing, may be performed by a common computing means, and image signal recordal may also be at a common location. Thus apparatus according to the present invention may comprise a central computing and/or recording facility, and the latter may also be arranged to send messages to tag wearers that pictures are awaiting them.

Furthermore, the provision of two or more cameras in the vicinity of a single location enables the location of a visible tag to be determined by stereo rangefinding, which is a technique known per se. Either of the two cameras, or a third camera could thereafter be used to point at the associated object.

In addition, the central facility may receive inputs from cameras at different locations, e.g. for storage and subsequent retrieval, optionally with signal processing at some stage. It may provide a means for associating all images relating to a particular tag so that a tag wearer only needs to look at relevant pictures.

Much of the forgoing description has been made in terms of controlling the camera settings or scanning in real time. However, the invention encompasses the case where a signal from a camera is recorded continuously together with the output of the tag detecting and reading means for subsequent action by the image signal control means, wherein it is the image signal alone which is edited for timing and composition.

Further features and advantages of the invention will become apparent on reading the appended claims, to which the reader is directed, and upon a consideration of the following description of an exemplary embodiment of the invention made with reference to the accompanying drawing in which

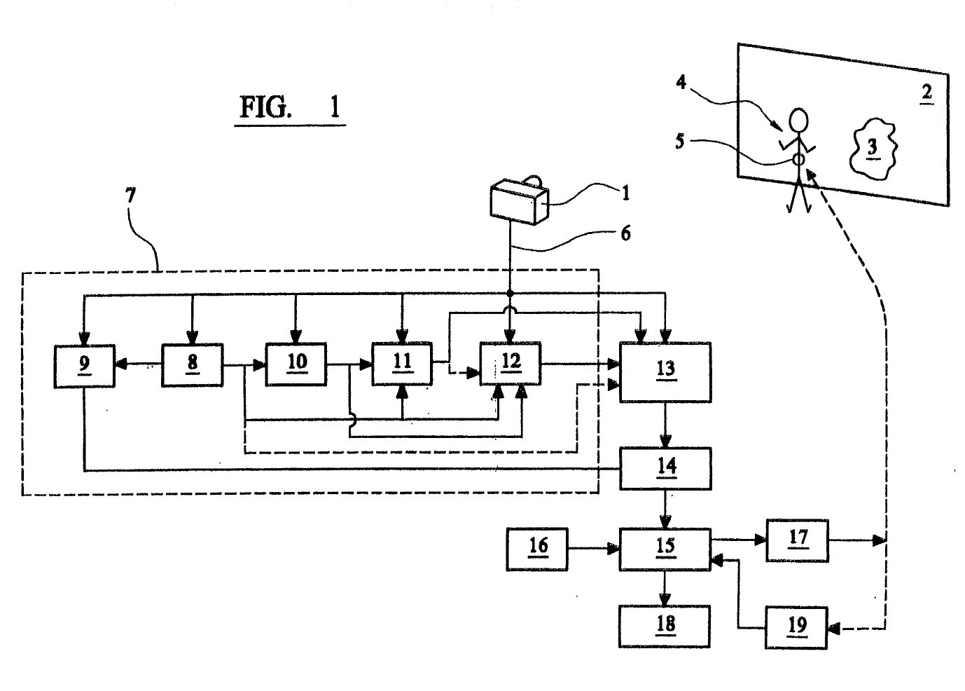

FIGS. 1 to 4 show in schematic form first, second, third and fourth embodiments of imaging apparatus in accordance with the invention; and

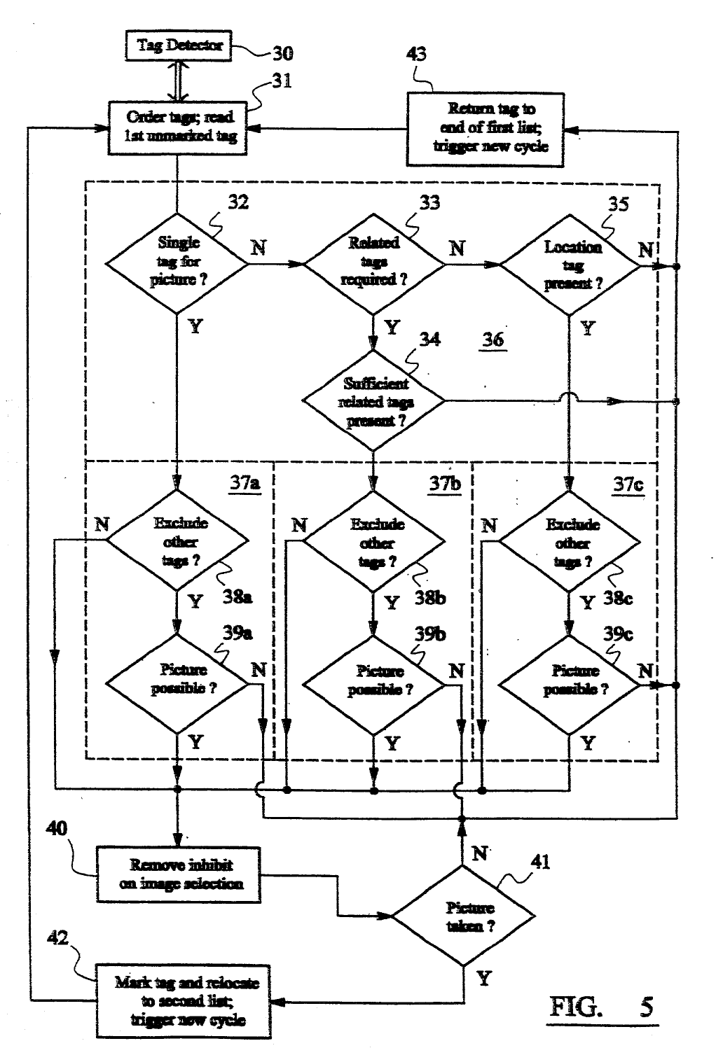

FIG. 5 is an outline decision tree for dealing with the presence of more than one tag.

In FIG. 1 a high resolution still electronic digital camera 1 with a fixed wide field of view is directed towards an area 2 within which an exhibit 3 is located and is being viewed by a visitor 4 wearing a visible tag 4 in the form of a bar code.

A central computing and storage facility 15 is arranged to receive an input from a device 16 such as a keyboard (or computer input including interactive screen) for storing details of the visitor 4 and any picture requirements (e.g. type of picture composition required, whether visitor is one of a group, etc.) when the visitor pays to enter the site where the exhibit is to be found, and means 17 for printing and issuing the tag 5 to the visitor. The tag information includes tag identity information, which is associated with the visitor details in the facility 15, and image signal operating instructions including information associated with the aforesaid picture requirements.

The image signal output of the camera is coupled to an image analysis means 7 including tag responsive means. The latter comprises tag locating circuitry 8 (tag locating means) coupled to tag reading circuitry (tag reading means) which includes an identification circuit 9 and an instruction circuit 10. Tag locating circuitry 8 is arranged to detect the presence of tag 4, its size and its location within the camera field of view. Based on the location of the tag provided by circuit 8, the identification circuit 9 derives the tag identity information from the bar code, and the instruction circuit 10 similarly retrieves the image signal operating instructions. The outputs of circuits 8 and 10 indicative of tag location and image signal operating instructions are fed together with the output 6 to image decision circuit 11 and event detector 12.

Image decision circuit 11 incorporates a plurality of sets of image compositional rules, and selects a set according to the output of circuit 10, whereupon it analyses the image as viewed by the camera and makes a decision regarding which area of the viewed image should be selected (equivalent to controlling camera pan, tilt and zoom).

Event detector 12 provides for the selection of a plurality of events which could be detected, for example the appearance of a smile, the sound of laughter, and the occurrence of a predetermined event triggered at the exhibit. To this end the detector 12 may comprise separate detection means, such as an audio transducer and circuitry adapted for detecting laughter, and an input from a trigger input to the exhibit. The image signal operating instructions provide instructions as to which event is to be selected for detection, and in the illustrated example this is the appearance of a smile.

Accordingly the event detector receives the output signal 6, the tag location signal from circuit 8, and the image signal operating instructions from circuit 10.

The outputs of decision circuit 11 and event detection circuit 12 are coupled to an image signal selection circuit 13 which is thus instructed as to the area of the image to be selected from the camera image signal and when that area is to be selected. The output thus provided is combined at combiner 14 with the tag identity information and recorded at the central computing and storage facility 15. Since the tag is visible, the image selection circuit may include means for replacing the area of the tag with an area of colour and texture closely resembling its surroundings, and for this purpose circuit 13 would also receive the tag location signal from circuitry 8.

Optionally, and preferably, the event detector 12 also receives an output from decision circuit 11 (shown in dashed lines) for making more intelligent event detection. For example, if the circuit 11 provides an output indicative of a time when the composition is suitable for picture recordal, this may be treated by circuit 12 as a further “event”; alternatively such a signal may be fed directly to circuit 13. In either case, however, it should be noted that other outputs of circuit 11 may still need to be coupled to circuit 13, for example an indication of a sub-area of the field of view which is suitable for the selected picture signal.

When the visitor leaves the site, the tag is identified by a reader 19 coupled to the facility 15 which responds by displaying a message on a screen 18 that one or more pictures of the visitor are awaiting inspection for possible purchase.

In a modification of this embodiment, the image signal from the camera is recorded continuously, and subsequently replayed to provide the signal 6 for input to the image analysis means and selection circuit 13.

In a further modification of this embodiment, the event detector merely provides an output a predetermined time after first detection of the tag. However, this is not so satisfactory, since it makes assumptions about the tag wearer which may not be justified.

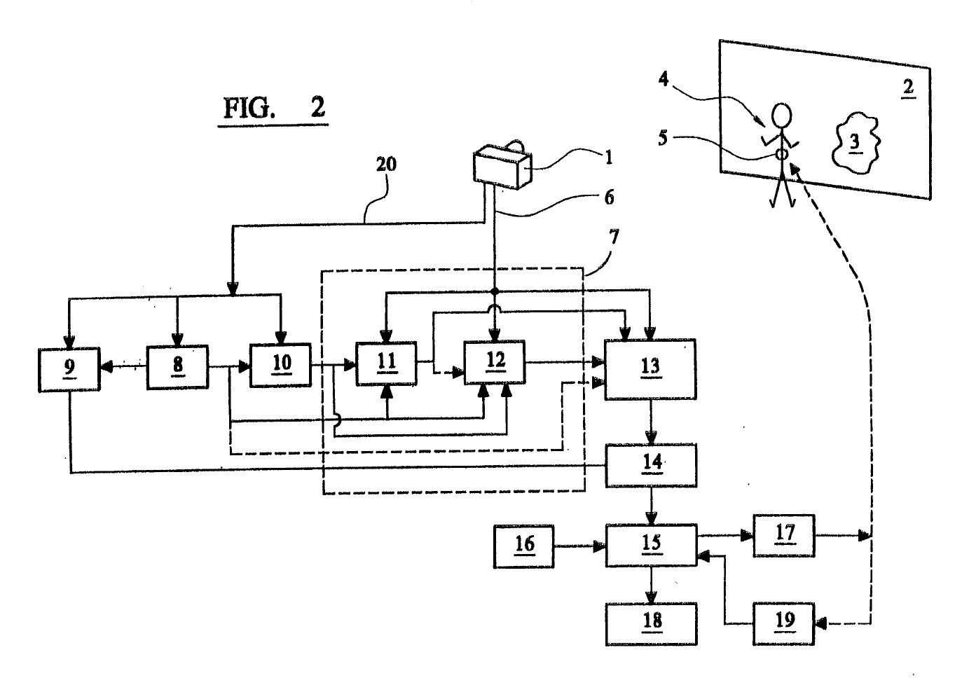

The embodiment of FIG. 2 is for use with tag in the form of an infra-red emitting bar code. To that end the camera comprises an internal beamsplitter providing a second image on a second sensor array for detecting infra-red only, whether by the use of filters, or a wavelength sensitive beamsplitter or by the use of appropriate wavelength sensitive sensors. The output 20 of the second array is coupled to the circuits 8 to 10 for determining tag identity and location, and image signal operating instructions, the visible image signal still being coupled to circuits 11 to 13. Otherwise FIG. 2 is similar to FIG. 1.

In a modification of FIG. 2, the tag is an infra-red light source modulated with the tag information on a 2 KHz carrier. This is detected by a plurality of individual sensors in the immediate vicinity of the camera for determination of the tag location by triangulation and rangefinding in circuit 8, and circuits 9 and 10 receive the demodulated signal for determining tag identity and image control operating instructions.

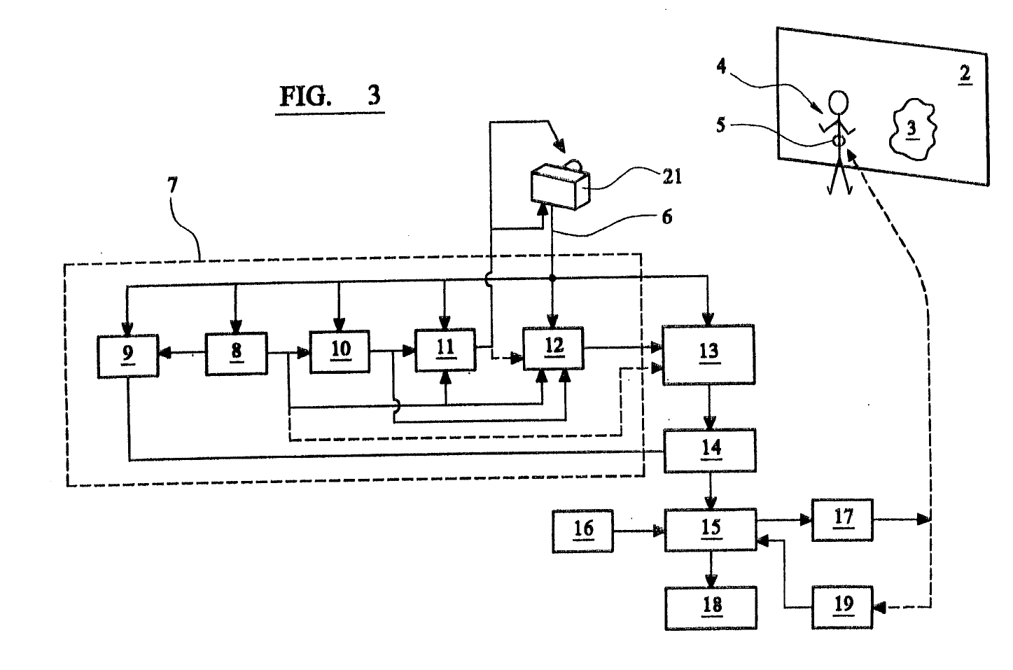

In the embodiment of FIG. 3 the camera 21 is provided with means for physically altering its settings, pan, tilt and zoom, and its sensor array is of lower overall resolution or density than that of camera 1 of FIGS. 1 and 2. However, the latter factor is compensated in use by the use of the camera settings to obtain the required picture, as opposed to selecting a limited image area from a larger one. In this embodiment, the output of decision circuit 11 is coupled to control the camera setting, as indicated by the two outputs to the camera from circuit 11, and the image signal selection circuit 13 is coupled to receive the output of event detector 12 and, optionally, tag location circuit 8.

In use, the circuit 11 is arranged to set the camera zoom to its widest angle, and/or to scan the camera over the available view (which may be greater than the instantaneous maximum camera field of view, using pan and tilt control), until a tag is detected by circuitry 8. Thereafter, circuit 11 controls the camera so that tag is centred in the instantaneous field of view, following which the arrangement works in generally the same fashion as that of FIG. 1. As in FIG. 1, an output of the decision circuit 11 indicative of when there is a picture suitable for recording may be coupled to the image signal selection circuit 13 (not shown in figure).

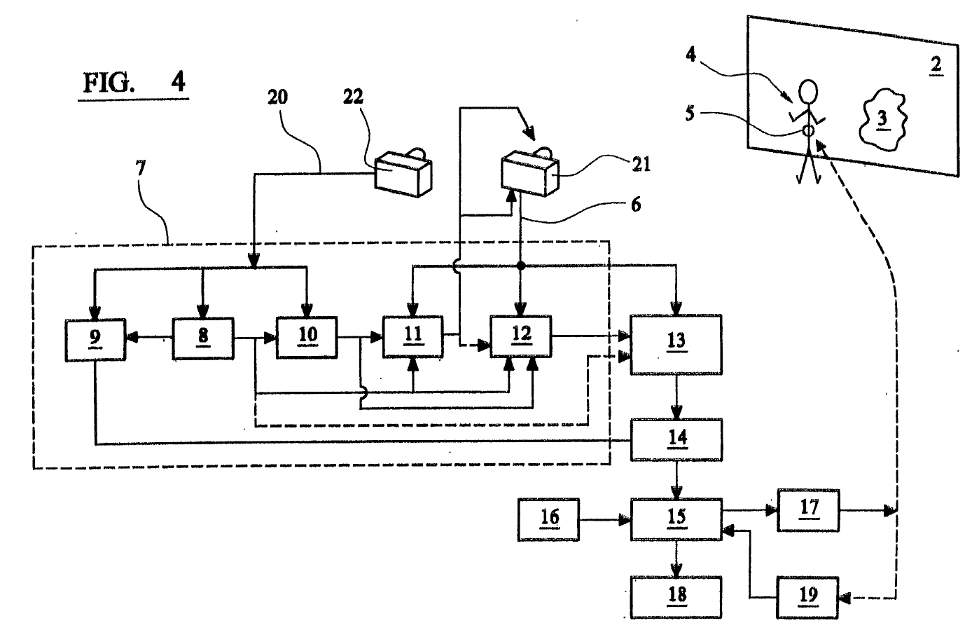

In FIG. 4, the tag is an infra-red emitting tag, and a second infra-red sensor array camera 22 is provided immediately adjacent the camera 21. The camera 22 is fixed with a wide field of view, and as in FIG. 2, the infra-red image output 20 is coupled to the circuits 8 to 10. Otherwise, the arrangement is similar to that of FIG. 3, in particular comprising a physically controllable camera 21 with a potentially narrow field of view.

FIG. 5 shows in outline form a version of logic applicable for coping with the simultaneous presence of more than one tag in the field of view, arranged to respond to tags which specify respectively (a) that only that tag needs to be present; (b) that a specified minimum number of related tags need to be present; and (c) that a location related tag needs to be present. It also deals with tags which specify that no tags other than that or those required should be in the picture. The logic is set to place an inhibit signal on the operation of the image selection circuit 13 unless certain conditions are met, as determined from the tag information.

Outputs from the tag detecting and location circuit 8, the tag identity circuit 9 the image signal operating circuit 10 and the image decision circuit 11 may all play their part, these circuits being represented in FIG. 5 by tag detector 30. The latter is in two-way communication with an arrangement 31 which receives information regarding the tags which are present and places them in a first list, which is ordered, for example by order of appearance of the tags. Arrangement 31 also provides a second list for tags which are present, but in direct response to the presence of which a picture has been initiated and taken, such tags being marked accordingly. Thus tags when first encountered are unmarked and are placed in the first list, but become marked and placed in the second list once a picture associated therewith and initiated on account thereof has been taken.

In conjunction with the arrangement 31 the tag detector 30 continuously monitors the arrival of new tags for placing in the first list, and the departure of existing tags for removal from the first and second lists as appropriate.

The arrangement 31 is periodically triggered to identify the first tag on the first list, if any, and is thereafter inhibited until an enable signal is received from an operation 42 or an operation 43. Identification of the first tag leads to a decision tree 36 in which decisions are made:-

32—Is only the presence of the single tag necessary for a picture?

33, 34—Are related tags required? If so are sufficient related tags present for a picture?

35—Is a location tag present? (this is the only remaining option in this arrangement)

If the answer to any of decisions 32, 34, 35 is “yes” a respective further decision tree 37a, 37b, 37 c is entered. Each of these trees is essentially the same and has the same output couplings so that only tree 37a will be described in detail. The following decisions are made in tree 37a:

38a—Is it necessary to exclude other tags?

39a—Is a picture possible (with exclusion of other tags)? This decision may need to be taken e.g. in conjunction with the image signal control means or particularly in conjunction with the image analysis means.

If the output of decision 38a is “no” or the output of decision 39a is “yes”, the inhibit on picture selection is removed 40, and subsequently a decision 41 is taken as to whether a picture was actually taken. It will be appreciated that decision 41 is necessary since other conditions necessary to the taking of a well composed picture may not pertain.

If a picture has been taken, the “yes” output of decision 41 is used 42 to mark the tag, which is then moved by arrangement 31 to the second list, so that it is not used again for initiating picture taking decisions, while its presence is still acknowledged for possible interaction with other tags for which no picture has yet been taken. In addition the arrangement 31 is enabled to enable the start a new cycle with a new tag (if any) from the first list.

If the output of decisions 34, 35, 39 (a/b/c) or 41 is “no”, so that no picture is possible at the time or has been taken, the tag is returned unmarked 43 to arrangement 31, where it is placed at the end of the first list. Provided the tag has not moved out of shot, the tag may then be used once more to initiate picture taking decisions. In addition the arrangement 31 is enabled to enable the start of a new cycle with a new tag (if any) from the first list.

The arrangement of FIG. 5 can be modified to deal with tags which require a plurality of images to be taken. Where the plurality is part of a sequence with predetermined timings, this will be dealt with automatically by removing the inhibit, operation 40, and taking the sequence before moving to a new tag. However, where a sequence is not required, a predetermined number of time separated images, one way of dealing with this is to enter the tag the predetermined number of times in the first list in arrangement 31, so that in effect it is treated as a separate tag for each of its cycles.

It will be understood that in any of the foregoing embodiments the image signal operating instructions may be such that a sequence is to be taken, say of three exposures at 2 second intervals, once selection of the picture signal is enabled. It should also be understood that the still camera could be replaced by a video camera, and that the tag information could then specify the length of the video clip if this is not predetermined in the system.

It should further be noted that although the preferred embodiments have been described in relation to a fixed camera installation, similar considerations can be applied to cameras which are worn or carried, and which may be placed appropriately by the tag wearer when a self or group picture is required, leaving the image signal control means to provide a composed picture at the appropriate moment.

1. Imaging apparatus for use with a tag providing information, said apparatus comprising an electronic camera for providing an image signal, a tag responsive circuitry arrangement including a tag locating arrangement for detecting the presence of a tag and determining its location relative to the camera and a tag reading arrangement for deriving said predetermined information from a detected tag, and image signal control circuitry for controlling the image signal in response to the output of said tag responsive circuitry to provide a selected picture signal.

2. Apparatus according to claim 1 wherein said image signal control circuitry is arranged for physical control of at least one of camera pan, tilt and zoom.

3. Apparatus according to claim 1 wherein said image signal control circuitry is arranged for controlling the scan of the electronic camera.

4. Apparatus according to claim 1 wherein said image signal control circuitry is arranged for editing the image signal from the camera.

5. Apparatus according to claim 1 wherein said predetermined information comprises image signal operating instructions, and said tag reading arrangement comprises instruction circuitry for obtaining the image signal operating instructions, the instruction circuitry being coupled to the image signal control circuitry.

6. Apparatus according to claim 5 wherein said predetermined information comprises tag identity information and said tag reading arrangement comprises identity circuitry for obtaining the tag identity information coupled to a combiner for combining said identity information with said selected picture signal.

7. Apparatus according to claim 1 and including an image signal analyser for receiving and analysing the image signal from the electronic camera.

8. Apparatus according to claim 7 wherein the tag is visible, and wherein the image signal analyser provides said tag reading arrangement.

9. Apparatus according to claim 7 wherein the image signal analyser comprises decision circuitry for making decisions on picture composition on the basis of a predetermined set of criteria, said decision circuitry being coupled to receive the image signal from the electronic camera and having an output coupled to the image signal control circuitry.

10. Apparatus according to claim 9 wherein the decision circuitry is coupled to the tag locating arrangement and is arranged to take account of the tag location.

11. Apparatus according to claim 9 wherein the decision circuitry is coupled to the tag reading arrangement and is arranged to take account of the output thereof.

12. Apparatus according to claim 1 wherein the image signal control circuitry comprises an image signal selection circuit coupled to receive said image signal for selectively passing a selected picture signal.

13. Apparatus according to claim 12 and including an event detector for detecting a predetermined event, the output of the event detector being coupled to the image signal selection circuit.

14. Apparatus according to claim 13 wherein said event detector includes an image signal analyser for receiving and analysing the image signal from the electronic camera.

15. Apparatus according to claim 1 wherein the image signal control circuitry is arranged so that the tag location has a predetermined spatial relation to the frame represented by said selected picture signal.

16. Apparatus according to claim 1 wherein the image signal control circuitry is arranged so that the tag has a predetermined relative size in the frame represented by said selected picture signal.

17. Apparatus according to claim 1 and including a recorder for recording and replaying said image signal from the electronic camera before said the selected picture signal is produced.

18. Apparatus according to claim 1 and including a recorder for recording said selected picture signal.

19. Apparatus according to claim 1 wherein the tag is infra-red, and the camera includes an IR sensor array for detecting the tag.

20. Apparatus according to claim 19 wherein the camera includes a beam splitter for directing light to said IR array.

21. Apparatus according to claim 1 wherein the image signal control circuitry comprises plural tag circuitry for reacting to the presence of a plurality of tags in the field of view of the camera.

22. Apparatus according to claim 21 wherein the image signal control circuitry comprises an image signal selection circuit coupled to receive said image signal for selectively passing a selected picture signal, the plural tag circuitry being coupled to the tag responsive circuitry and arranged to selectively enable the image signal selection circuit in response to the said predetermined information from at least one said tag.

23. Apparatus according to claim 22 wherein the image signal analyser comprises decision circuitry for making decisions on picture composition on the basis of a predetermined set of criteria, said decision circuitry being coupled to receive the image signal from the electronic camera and having an output coupled to the image signal control circuitry, the plural tag circuitry being also coupled to the image decision circuitry and arranged so that the selective enabling of the image signal selection circuit is dependent on the output of the image decision circuitry.

24. Apparatus according to claim 21 wherein the plural tag circuitry is arranged to identify related tags.

25. Apparatus according to claim 21 wherein the plural tag circuitry is arranged to selectively enable the image signal selection circuit in response to the presence of a single tag if instructed to do so by the said predetermined information thereof.

26. Apparatus according to claim 21 wherein the plural tag circuitry is arranged to selectively enable the image signal selection circuit only in response to the presence of plural tags if instructed to do so by the said predetermined information on at least one said tag.

27. Apparatus according to claim 21 wherein the plural tag circuitry is arranged to selectively enable the image signal selection circuit only in the absence of specified other tags if instructed to do so by the said predetermined information on at least one said tag.

28. Apparatus according to claim 1 wherein said tag reading arrangement includes address deriving circuitry for deriving an address from said information and for directing a message thereto.

29. Imaging apparatus for use with a visible tag providing information, said apparatus comprising an electronic camera for providing an image signal, an image signal analyser for receiving and analysing the image signal from the electronic camera for detecting the presence of a tag, for determining its location relative to the camera and for deriving said predetermined information from a detected tag, the image signal analyser further comprising decision circuitry for making decisions on picture composition on the basis of a predetermined set of criteria, the apparatus further comprising image signal control circuitry for controlling the image signal in response to the output of said image analysis circuitry to provide a selected picture signal.

30. A method of imaging a scene with an electronic camera in which scene at least one information bearing tag is present comprising the step of detecting the tag and determining its location relative to the camera field of view, the step of deriving said information from the tag, and the step of controlling an image signal from the signal from the camera at least in part on at least one of said location and said information to provide a selected picture signal.

31. A method according to claim 30 wherein said controlling step includes controlling the direction of the camera according to said location.

32. A method according to claim 30 wherein said controlling step includes controlling the zoom of the camera according to the distance of the tag from the camera.

33. A method according to claim 30 wherein said controlling step includes the step of controlling the camera scan.

34. A method according to claim 30 wherein said controlling step includes the step of editing the image signal from the camera.

35. A method according to claim 30 and including the step of recording and replaying the image signal from the camera before at least part of said step of controlling the signal.

36. A method according to claim 30 and including the step of recording said selected picture signal.

37. A method according to claim 30 and including the step of analysing the image signal from the camera.

38. A method according to claim 37 wherein the tag is visible and said analysing step provides the step of determining the location of the tag relative to the camera field of view and/or the step of deriving said information from the tag,

39. A method according to claim 37 and wherein said analysing step includes making a decision on best picture composition according to predetermined criteria, and said step of controlling the image signal is responsive to said decision.

40. A method according to claim 30 and including the step of triggering the camera in response to the detection of a predetermined event.

41. A method according to claim 40 wherein the predetermined event is visual and is detected by analysing the image signal from the camera.

42. A method according to claim 40 wherein the predetermined event is nonvisual and is detected by a dedicated sensor.

43. A method according to claim 42 wherein the event is audible.

44. A method according to claim 42 wherein the event is receipt of an instruction emitted by the tag in response to actuation by a wearer.

45. A method according to claim 30 and including the step of enabling said provision of a selected picture signal only when a plurality of tags having a predetermined relation are in the picture.

46. A method according to claim 45 and including the step of disabling said provision of a selected picture signal if any tag not having said predetermined relation is in the picture.

47. A method according to claim 30 wherein the tag information includes tag identity information, the method including the steps of deriving the identity information and combining it with the selected picture signal.

48. A method of imaging a scene with an electronic camera in which scene at least one visible information bearing tag is present comprising the step of analysing the image signal to detecting the tag, determine its location relative to the camera field of view, deriving said information from the tag, and making decisions on picture composition on the basis of a predetermined set of criteria, and the step of controlling an image signal from the signal from the camera at least in part on the result of said analysing step.
